(19) United States
(12) Patent Application Publication
(10) Pub. No.: US 2016/0037143 A1
(43) Pub. Date: Feb. 4, 2016

(54) METHOD AND DEVICE FOR AUTOMATICALLY GENERATING AND PROJECTING MULTI-SURFACE IMAGES

(71) Applicant: Jeong-Ha YANG, Seoul (KR)

(72) Inventor: Jeong-Ha YANG, Seoul (KR)

(73) Assignees: EASYWITH CO., LTD, Seoul (KR); EASYWITH CO., LTD, Seoul (KR)

(21) Appl. No.: 14/348,571

(22) PCT Filed: Mar. 20, 2014
(86) PCT No.: PCT/KR2014/002369

§ 371 Date: Mar. 28, 2014

(30) Foreign Application Priority Data
Mar. 17, 2014 (KR) 1020140031241

(51) Int. Cl. H04N 9/31; G06T 7/00; G06T 7/40; H04N 5/225

(52) U.S. Cl. CPC H04N 9/3185; H04N 9/3176; H04N 5/2251; G06T 7/0085; G06T 7/408

(57) ABSTRACT

A method for automatically generating and projecting multi-surface image which automatically recognizes a plurality of projection surfaces using an image projector and a camera and projects images separately, includes: projecting scan image for pixel determination on a scan area including the plurality of projection surfaces using the image projector; recognizing the plurality of projection surfaces using image of the scan area including the plurality of projection surfaces photographed by the camera; matching the projection surfaces recognized by the image photographed by the camera while the scan image is projected and corresponding pixels of a display screen of the image projector; and projecting image which fills the pixel area of the display screen of the image projector corresponding to the areas of the projection surfaces.

### TECHNICAL FIELD

The present invention relates to a method and a device which can automatically recognizes multi-surface projection surface to which images will be projected and can project images on the recognized projection surface.

### BACKGROUND ART

There is a trend for substituting fixed picture of background with images with the development of image technology. For example, a method for realizing background of stage for performance using image projection.

In case of projecting images for the background of performance, it is not difficult to project images on a single projection surface, but several problems should be solved to project images on a plurality of projection surfaces.

### DETAILED DESCRIPTION OF THE INVENTION

Technical Problem

The present invention has been made in an effort to provide a method and a device which automatically recognize a plurality of projection surfaces and can project multi-surface images

Technical Solution

In an exemplary embodiment of the present invention, a method for automatically generating and projecting multi-surface image which automatically recognizes a plurality of projection surfaces using an image projector and a camera and projects images separately, includes: projecting scan image for pixel determination on a scan area including the plurality of projection surfaces using the image projector; recognizing the plurality of projection surfaces using image of the scan area including the plurality of projection surfaces photographed by the camera; matching the projection surfaces recognized by the image photographed by the camera while the scan image is projected and corresponding pixels of a display screen of the image projector; and projecting image which fills the pixel area of the display screen of the image projector corresponding to the areas of the projection surfaces.

In the projecting the scan image, the scan image to equally divide the scan area with total pixels of the display screen of the image projector may be projected.

The projecting the scan image may include: sequentially projecting scan images which sequentially divide the scan area in a horizontal direction with a predetermined time interval; and sequentially projecting scan images which sequentially divide the scan area in a vertical direction with a predetermined time interval.

In the recognizing the plurality of the projection surfaces, the projection surfaces may be recognized based on an edge detection and a closed shape determination based on color difference in the photographed image.

In an exemplary embodiment of the present invention, a device for automatically generating and projecting multi-surface image which automatically recognizes a plurality of projection surfaces and projects images separately, includes: a projector which is provided to project image on an area including the plurality of projection surfaces; a camera which photographs an area including the plurality of projection surfaces; and a controller which receives the images photographed by the camera and controls the image projector. The image projector projects scan image for pixel determination on a scan area including the plurality of the projection surfaces, the camera photographs the scan area while the scan image is projected and transmits a corresponding photographed image to the controller, the controller recognizes the plurality of the projection surfaces based on the photographed image of the area including the plurality of the projection surfaces, and the controller matches areas of the recognized projection surfaces and corresponding pixels of a display screen of the image projector and controls the image projector to project image filling pixel area of the display screen of the image projector corresponding to the area of the projection surfaces.

The image projector may project the scan image to equally divide the scan area with total pixels of the display screen of the image projector.

The image projector may sequentially projects scan images which sequentially divide the scan area in a horizontal direction with a predetermined time interval and may sequentially projects scan images which sequentially divide the scan area in a vertical direction with a predetermined time interval.

The controller may recognize the projection surfaces based on an edge detection and a closed shape determination based on color difference in the photographed image.

### Advantageous Effects

According to the present invention, by automatically recognizing a plurality of projection surfaces and matching pixels of an image projector corresponding to areas of the projection areas and projecting images, the plurality of projection surfaces can be automatically recognized and desired images can be projected onto the recognized projection surfaces.

### BRIEF DESCRIPTION OF DRAWINGS

FIG. 1 is a drawing schematically showing a device for automatically generating and projection multi-surface images according to an embodiment of the present invention.

FIG. 2 is a block diagram showing the connection of a device for automatically generating and projection multi-surface images according to an embodiment of the present invention.

FIG. 3 is a drawing for explaining the process for scan image projection in a horizontal direction for pixel matching according to a method for automatically generating and projection multi-surface images according to an embodiment of the present invention.

FIG. 4 is a drawing for explaining the process for scan image projection in a vertical direction for pixel matching according to a method for automatically generating and projection multi-surface images according to an embodiment of the present invention.

FIG. 5 is a drawing showing a state in which images are projected onto a plurality of projection surfaces according to a device and a method for automatically generating and projection multi-surface images according to an embodiment of the present invention.

### DETAILED DESCRIPTION OF THE EMBODIMENTS

Hereinafter, embodiments of the present invention will be explained referring to the attached drawings.

The present invention relates to a method and a device for automatically recognizing a plurality of projection surfaces and projecting images respectively depending on positions and shapes of the recognized. At this time, the projection surfaces are plural and may be three-dimensional two-dimensional projection surfaces.

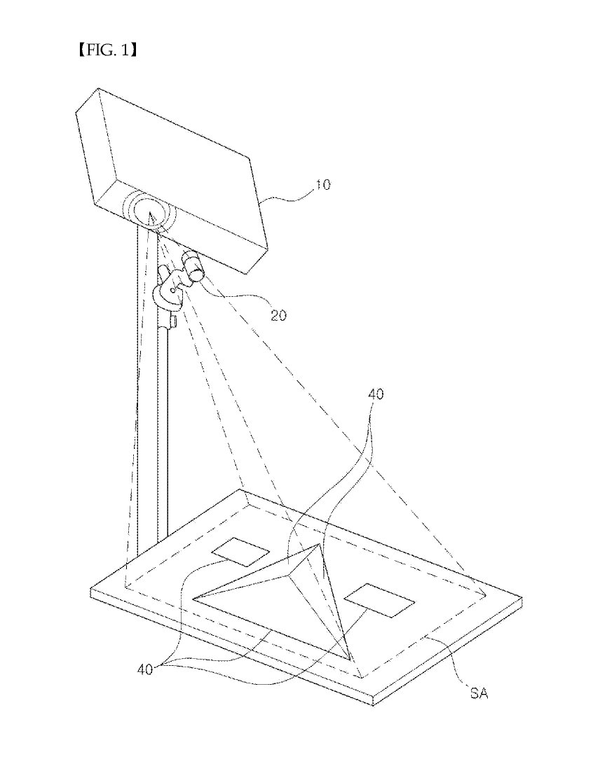

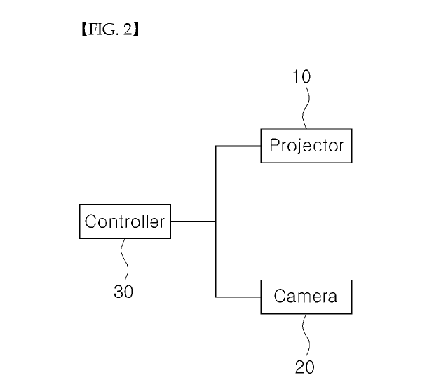

Referring to FIG. 1 and FIG. 2, a method and a device for automatically generating and projecting multi-surface images according to an embodiment of the present invention includes an image projector 10, a camera 20 and a controller 30.

The image projector 10 may be controlled by the controller 30, and may be a conventional projector which can project images. The camera 20 takes images and transmits a corresponding data to the controller 30. The controller 30 may be connected to the camera 20 and the image projector 10, and receives the pictured image from the camera 20 and generates images which will be projected by the image projector 10 and transmits the generated images to the image projector 10. The controller 30 may be a computer system, and may include related hardware and software which are configured to perform functions such as the projection surface recognition, image generation and control.

A plurality of projection surfaces 40 are recognized using image of scan area SA which is photographed by the camera 20. In detail, the projection surfaces 40 can be recognized based on edge detection and closed shape recognition using color difference in the photographed image. At this time, the recognition of the projection surfaces 40 from the photographed image can be performed using the known image processing algorithm, and for example the projection surfaces 40 can be recognized based on edge detection of the projection surface and a closed shape detection using Canny Edge Detection algorithm, a closed shape detection algorithm or the like. The projection surfaces 40 are shown in a simple shape for the ease of description, but the shape and the position of the projection surfaces can be varied.

Meanwhile, an area of the projection surfaces 40 and the corresponding pixels of display screen of the image projector 10 are matched using the image projector 10 and the camera 20.

Concretely, scan images for pixel identification are projected on the scan area SA including the plurality of projection surfaces 40 using the image projector 10.

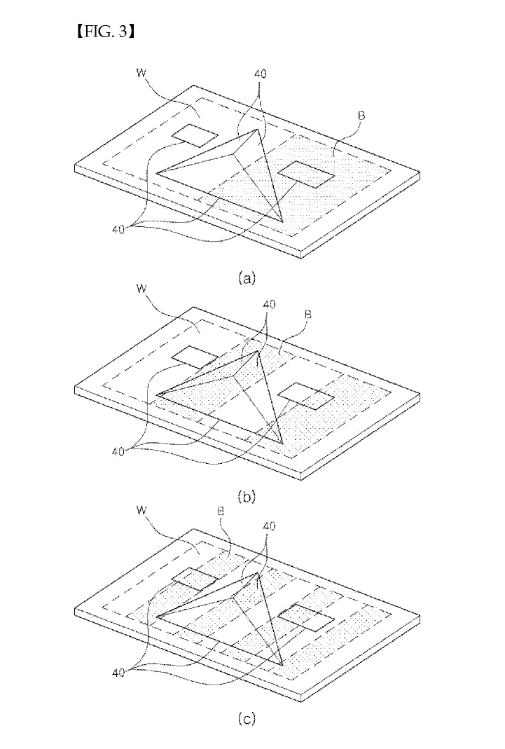

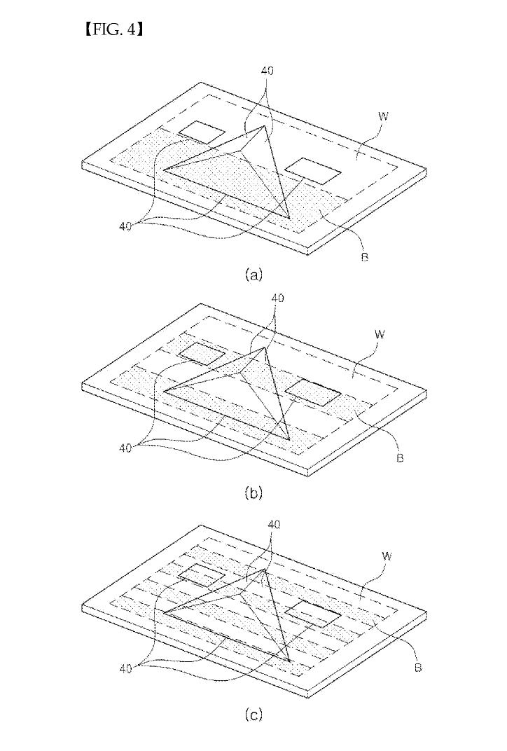

Referring to FIG. 3 and FIG. 4, the scan images can be projected sequentially in a horizontal direction and a vertical direction throughout the scan area SA.

First, referring to FIG. 3, the projection of scan image in a horizontal direction can be performed by projecting white scan image W and black scan image B which sequentially divide the total scan area SA in a horizontal direction. For example, at the first stage the scan image having a white image W at the left side and a black image B at the right side which divides equally the area in a horizontal direction is projected, and then with a predetermined time interval the area where the white image is projected in the former projection is divided equally into two portions in a horizontal direction, and a white scan image is projected on the left portion and a black image is projected on the right portion. That is, as shown in (a) of FIG. 3, the scan image which is divided into two portions in a horizontal direction is projected, and subsequently with a predetermined time interval as shown in (b) of FIG. 3, the respective divided portions are again divided into two portions respectively so that the scan image having four divided portions is projected, and then with predetermined time interval as shown in (c) of FIG. 3, the respective divided portions are divided into two portions respectively so that the scan image having eight divided portions is projected. As such a process of projecting the scan image which divides the respective divided portions of the former projection stage into two portions respectively is repeated with a predetermined time interval. Accordingly in a state that an n-th scan image is projected the total scan area are equally divided into 2ⁿ portions in a horizontal direction with alternating white and black images.

Referring to FIG. 4, projection of scan images in a vertical direction can be performed in the same way. That is, the projection can be performed by projecting white scan image W and black scan image B which sequentially divide the total scan area SA in a vertical direction. In the same way with FIG. 3, as shown in (a) of FIG. 4, the scan image which is divided into two portions in a vertical direction is projected, and subsequently with a predetermined time interval as shown in (b) of FIG. 4, the respective divided portions are again divided into two portions respectively so that the scan image having four divided portions is projected, and then with predetermined time interval as shown in (c) of FIG. 4, the respective divided portions are divided into two portions respectively so that the scan image having eight divided portions is projected. As such a process of projecting the scan image which divides the respective divided portions of the former projection stage into two portions respectively is repeated with a predetermined time interval. Accordingly in a state that an n-th scan image is projected the total scan area are equally divided into 2ⁿ portions in a vertical direction with alternating white and black images.

While the scan images are projected onto the scan area as such, the camera 20 photographs the scan area.

At this time, the projections of scan images in a horizontal direction and in a vertical direction can be performed until the number of the divided portions in each direction becomes equal to the number of the pixels of the image projector 10 in a horizontal direction and in a vertical direction. For example, in case that the number of the horizontal pixels of the image projector 10 is 1024(=2¹⁰) and the number of the vertical pixels of the image projector 10 is 2048(=2¹¹), the scan image projection in a horizontal direction is sequentially performed in 10 times, and the scan image projection in a vertical direction is sequentially performed in 11 times.

Meanwhile, in case that the number of the pixels does not coincide with into 2ⁿ, the projection is performed until the scan image having divided portions greater than the number of the pixels is projected, and the redundant portion is projected out of the scan area, so the same image scan can be performed. For example, in case the number of the pixels is 760, the projection is performed in 10 times and the portions beyond the 760 may be projected out of the scan area.

By the photographed image taken during the scan image projection as such, it can be known how the colors of the respective divided area (area corresponding to the respective pixel of the image projector) of the scan area have been changed during the flow of time. For example, in case that the scan image is projected in the above-described manner, an area corresponding to the uppermost and the left end is maintained in the white state, and an area corresponding to the lower end and the right end is maintained in the black state, and change of color of the respective divided areas can be obtained. That is, since the change of color of the scan image of the divided areas corresponding to the respective pixels of the image projector 10, the respective areas of the recognized projection surface 40 and the corresponding pixels of the display screen of the image projector 10 can be matched with each other.

It can be known that which groups of pixels of the image projector 10 correspond to areas of the respective projection surfaces 40 based on the information obtained by the matching, and by making the respect groups of pixels of the image projector 10 be displayed with the desired images and projecting the same, the desired images can be displayed on the respective projection surfaces 40. At this time, the respective images which will be respectively projected on the plurality of projection surfaces 40 can be obtained by extracting the images of the corresponding area from the one entire images, and alternatively can also be obtained by combining respective images corresponding to the plurality of projection surfaces. Such an image matching can be performed by one of the conventional methods, and further detailed description for the same will be omitted.

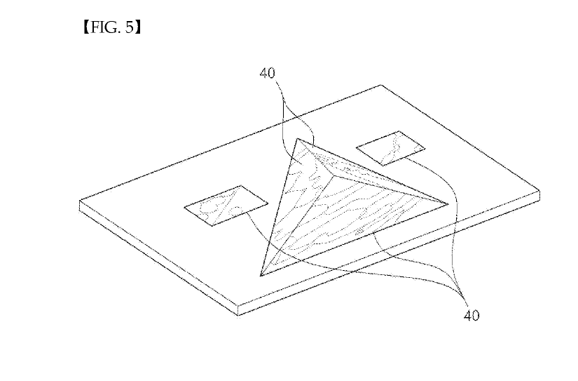

By projecting the obtained images via the image projector 10, as shown in FIG. 5, separate images can be displayed on the respective projection surfaces 40.

In case that the embodiment of the present invention is applied to a stage device for performance, when the projection surfaces are changed for the change of background during the performance, desired images can be projected onto the changed projection surfaces by performing the projection surface recognition, pixel matching, and image matching and projecting the image.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

The present invention relates to an image display device and method and can be applied to various fields such as stage device for performance, so that the present invention has an industrial applicability.

1. A method for automatically generating and projecting multi-surface image which automatically recognizes a plurality of projection surfaces using an image projector and a camera and projects images separately, comprising:
projecting scan image for pixel determination on a scan area including the plurality of projection surfaces using the image projector;
recognizing the plurality of projection surfaces using image of the scan area including the plurality of projection surfaces photographed by the camera;
matching the projection surfaces recognized by the image photographed by the camera while the scan image is projected and corresponding pixels of a display screen of the image projector; and
projecting image which fills the pixel area of the display screen of the image projector corresponding to the areas of the projection surfaces.

2. The method of claim 1, wherein in the projecting the scan image, the scan image to equally divide the scan area with total pixels of the display screen of the image projector is projected.

3. The method of claim 1, wherein the projecting the scan image comprises:
sequentially projecting scan images which sequentially divide the scan area in a horizontal direction with a predetermined time interval; and
sequentially projecting scan images which sequentially divide the scan area in a vertical direction with a predetermined time interval.

4. The method of claim 1, wherein in the recognizing the plurality of the projection surfaces, the projection surfaces are recognized based on an edge detection and a closed shape determination based on color difference in the photographed image.

5. A device for automatically generating and projecting multi-surface image which automatically recognizes a plurality of projection surfaces and projects images separately, comprising:
a projector which is provided to project image on an area including the plurality of projection surfaces;
a camera which photographs an area including the plurality of projection surfaces; and
a controller which receives the images photographed by the camera and controls the image projector,
wherein the image projector projects scan image for pixel determination on a scan area including the plurality of the projection surfaces, the camera photographs the scan area while the scan image is projected and transmits a corresponding photographed image to the controller, the controller recognizes the plurality of the projection surfaces based on the photographed image of the area including the plurality of the projection surfaces, and the controller matches areas of the recognized projection surfaces and corresponding pixels of a display screen of the image projector and controls the image projector to project image filling pixel area of the display screen of the image projector corresponding to the area of the projection surfaces.

6. The device of claim 5, wherein the image projector projects the scan image to equally divide the scan area with total pixels of the display screen of the image projector.

7. The device of claim 5, wherein the image projector sequentially projects scan images which sequentially divide the scan area in a horizontal direction with a predetermined time interval and sequentially projects scan images which sequentially divide the scan area in a vertical direction with a predetermined time interval.

8. The device of claim 5, wherein the controller recognizes the projection surfaces based on an edge detection and a closed shape determination based on color difference in the photographed image.
